(19) United States
(12) Patent Application Publication
(10) Pub. No.: US 2026/0330823 A1
(43) Pub. Date: Oct. 22, 2026

(54) Systems and Methods for Non-contact Soil Organic Matter Sensing

(71) Applicant: AGCO Corporation, Duluth, GA (US)

(72) Inventors: Jeffrey Michael Zimmerman, Lake Park, IA (US); Darren Goebel, Duluth, GA (US); Ravindra Godbole, Duluth, GA (US); Alexander Quentin Susko, Jackson, MN (US)

(21) Appl. No.: 19/122,724

(22) PCT Filed: Jun. 23, 2023
(86) PCT No.: PCT/IB2023/056493

§ 371 Date: Apr. 18, 2025

Related U.S. Application Data
(60) Provisional application No. 63/380,480, filed on Oct. 21, 2022.

(51) Int. Cl. G06V 20/10; A01B 63/02; A01B 76/00; G06V 10/26; G06V 10/764; G06V 10/82; G06V 20/56

(52) U.S. Cl. CPC G06V 20/10; A01B 63/02; A01B 76/00; G06V 10/26; G06V 10/764; G06V 10/82; G06V 20/56

(57) ABSTRACT

An image of soil is received from a camera and is associated with location data from a GPS sensor. The image is divided into sub-images, which are processed using a first ML model. The first ML model is trained to classify images into either soil or residue. The sub-images classified as soil are processed using a second ML model, which is trained to classify images into either high organic matter or low organic matter. The second ML model is trained on image data where a mean and standard deviation of RGB data of the image data provides an indication of an amount of organic matter in the imaged soil. An organic matter map is then generated.

### CROSS-REFERENCE TO RELATED APPLICATION

This application claims the benefit of the filing date of U.S. Provisional Patent Application 63/380,480, “Systems and Methods for Non-Contact Soil Organic Matter Sensing,” filed Oct. 21, 2022, the entire disclosure of which is incorporated herein by reference.

### TECHNICAL FIELD

The present disclosure relates to agricultural implements, and more particularly, to sensing an amount of organic matter present in soil.

### BACKGROUND

An organic matter content of soil affects the soil's nutrient holding capacity, water holding capacity, crop yield potential, and correlates to carbon sequestration, among other things. Furthermore, seed placement decisions are, in part, based on the organic matter content of the soil. While an organic matter content doesn't vary much from year-to-year, the content amount may vary significantly across a field.

Typical agricultural implements are designed to apply fertilizers, pesticides, and the like at uniform rates. In addition, typical agricultural implements are designed to plant seeds at uniform rates across a field. The variance of an organic matter content is not taken into account. This conventional approach to agriculture often results in over- and/or under-application of fertilizers, pesticides, and the like, at various points across the field. In addition, such an approach results in over and/or under seeding across the field.

### SUMMARY

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

In one aspect, a system for non-contact sensing of soil organic matter is provided. The system includes a global positioning system (GPS) sensor and a residue and organic matter sensing system. The residue and organic matter sensing system includes an optical sensor configured to capture an image of soil in an agricultural field, and a controller operatively coupled in communication to the optical sensor. The controller is programmed, via computer-executable instructions, to receive the image from the optical sensor. The controller receives location data from the GPS sensor and associates the location data with the image. The controller divides the image into a plurality of sub-images. The plurality of sub-images are processed using a first artificial intelligence (AI)/machine learning (ML) model. The first ML model is trained to classify images into the following first classes: soil or residue. Each sub-image of the plurality of forward sub-images is classified, using the first ML model, into one of the first classes. The sub-images classified in the soil class are then processed using a second ML model. The second ML model is trained to classify images into the following second classes: high organic matter or low organic matter. The second ML model is trained, using supervised learning, on image data where a mean and standard deviation of the RGB data of the image data provides an indication of an amount of organic matter in the imaged soil. Each sub-image of the sub-images classified in the soil class are then classified, using the second ML model, into one of the second classes. An organic matter map is then generated based on the associated GPS location data and the second classifications of the sub-images classified in the soil class.

In another aspect, a method for non-contact sensing of organic matter within soil of an agricultural field is provided. The method is performed by a controller attached to a tow vehicle traversing a field. The method includes receiving an image from an optical sensor attached to the tow vehicle. The image includes an image of the soil within the agricultural field. The method also includes receiving, from a global positioning system (GPS) sensor attached to the vehicle, location data. The method includes associating the location data with the image and dividing the image into a plurality of sub-images. Furthermore, the method includes processing the plurality of sub-images using a first artificial intelligence (AI)/machine learning (ML) model. The first ML model is trained to classify images into the following first classes: soil or residue. Additionally, the method includes classifying, using the first ML model, each sub-image of the plurality of sub-images into one of the first classes. The method includes processing the sub-images classified in the soil class using a second ML model. The second ML model is trained to classify images into the following second classes: high organic matter or low organic matter. The second ML model is trained, using supervised learning, on image data where a mean and standard deviation of RGB data of the image data provides an indication of an amount of organic matter in the imaged soil. Furthermore, the method includes classifying, using the second ML model, each sub-image of the sub-images classified in the soil class into one of the second classes. Moreover, the method includes generating an organic matter map based on the associated GPS location data and the second classifications of the sub-images classified in the soil class.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a side elevation schematic of a tow vehicle coupled to an agricultural implement;

FIG. 2 is a top view schematic of the tow vehicle and the agricultural implement shown in FIG. 1;

FIG. 3 is an architectural diagram of a residue and organic matter sensing platform of a sensing system for use with the tow vehicle and agricultural implement shown in FIGS. 1 and 2;

FIG. 4 is a flowchart illustrating an exemplary computer-implemented method for determining an amount of residue on a soil surface of an agricultural field using the residue and organic matter sensing platform shown in FIG. 3; and

FIG. 5 is a flowchart illustrating an exemplary computer-implemented method for determining an amount of organic matter in soil using the residue and organic matter sensing platform shown in FIG. 3.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be clear to those skilled in the art from the description. For example, a feature, structure, act, etc. described in one embodiment may also be included in other embodiments but is not necessarily included. Thus, the present technology can include a variety of combinations and/or integrations of the embodiments described herein.

In the following specification and the claims, reference will be made to several terms, which shall be defined to have the following meanings. The singular forms “a,” “an,” and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and the claims, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, directional references, such as, “top,” “bottom,” “front,” “back,” “side,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

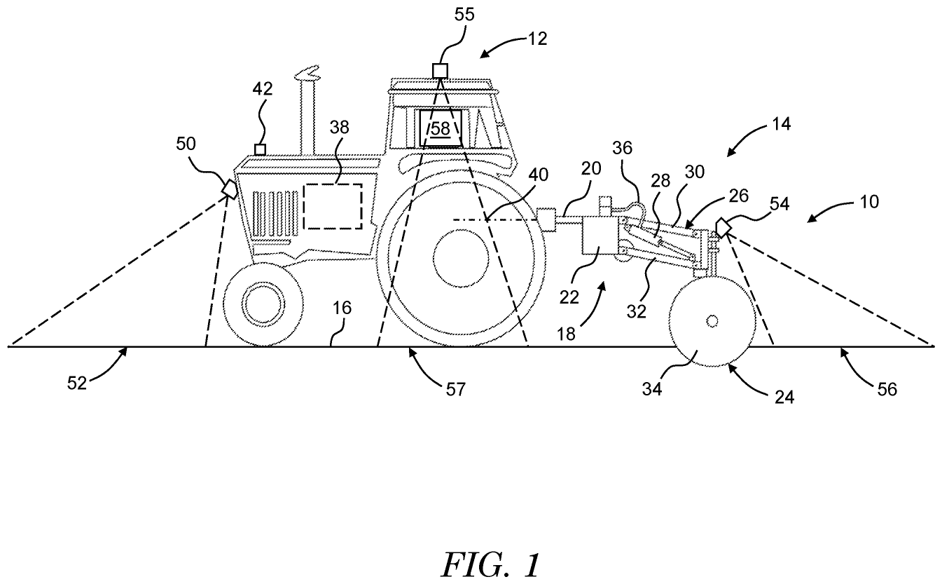

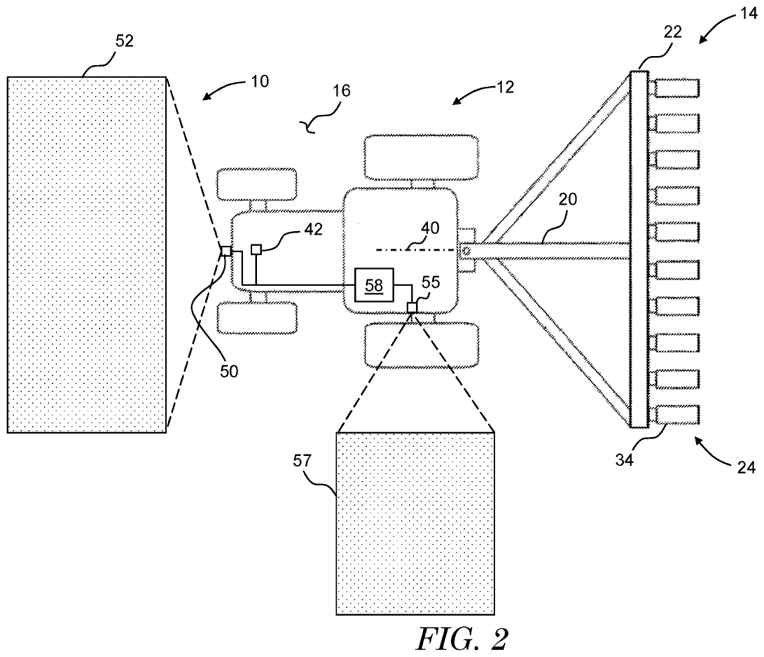

FIG. 1 is a side elevation schematic of a tow vehicle 12 (e.g., a tractor) coupled to an agricultural implement 14 (e.g., a tillage implement, such as a disk, ripper, plow, etc.), in accordance with one aspect. FIG. 2 is a top view schematic of the tow vehicle 12 and the agricultural implement 14 shown in FIG. 1. It is noted that, although the agricultural implement 14 is depicted as a tillage implement, the agricultural implement 14 may include, for example, a seed-planting implement or planter, or any other suitable equipment or implement that has components and/or tools configured to engage soil within an agricultural field 16 (broadly, a “field”).

In the example embodiment, the agricultural implement 14 includes a wheeled chassis 18 having a forwardly projecting tongue 20 that adapts the agricultural implement 14 to be hitched to the tow vehicle 12. The tow vehicle 12 and agricultural implement 14 traverse the field 16, which has various amounts of residue and organic matter in the soil. As the tow vehicle 12 traverses the field 16, the agricultural implement 14 executes a tillage operation on the soil. While depicted as a separate unit being towed, it is noted that the agricultural implement 14 may include self-driven agricultural implements that may execute various operations without being towed by a separate vehicle.

In the example embodiment, the wheeled chassis 18 of the agricultural implement 14 includes a frame 22. The frame 22 is connected to the tongue 20 and generally extends in an aft direction away from the tongue 20. A soil-engaging assembly 24 is hingedly coupled to the frame 22 by an adjustable arm assembly 26. The soil-engaging assembly 24 is configured to manipulate soil within the field 16. The adjustable arm assembly 26 includes a lift mechanism 28 (e.g., a hydraulic cylinder) and two (2) stabilizing arms 30 and 32. The stabilizing arms 30 and 32 extend between the frame 22 and the soil-engaging assembly 24. The soil-engaging assembly 24 can be raised or lowered with respect to a ground surface of the field 16 via the lift mechanism 28.

The soil-engaging assembly 24 includes a plurality of tools 34, such as disks, shanks, or the like. It is contemplated, however, that any other tools may additionally (or alternatively) be utilized. In some aspects, a plurality of wheel assemblies may also be coupled to the frame 22 to support the frame 22 on the ground.

In the example, the adjustable arm assembly 26 is operable to raise and lower at least the soil-engaging assembly 24 to a desired height during operation, and to raise and lower the soil-engaging assembly 24 to, respectively, a non-operational transport height and a selected operational height. The adjustable arm assembly 26 may employ substantially any suitable lifting technology, such as a hydraulic mechanism or a mechanical mechanism. In one implementation, the adjustable arm assembly 26 may include at least one lift mechanism 28 and at least one hydraulic lift circuit 36. The hydraulic lift circuit 36 is configured to control the movement of hydraulic fluid to and from the lift mechanism 28 to, respectively, raise and lower the soil-engaging assembly 24.

The tow vehicle 12 also includes an engine 38. The engine 38 provides power to the agricultural implement 14, and more specifically, to the lift mechanism 28. In particular, the engine 38 of the tow vehicle 12 provides power to the agricultural implement 14 via a power take off (PTO) shaft 40. The tow vehicle 12 also includes a global positioning system (GPS) receiver 42 for coupling in communication to and transmitting input signals (i.e., inputting location information) to a residue and/or organic matter sensing system 10 (described further herein), which may be carried by the tow vehicle 12 and/or the agricultural implement 14. The GPS receiver 42 utilizes GPS technology to detect a location of the tow vehicle 12 and the agricultural implement 14 in the field 16, for example, at desired intervals (e.g., during a primary tillage operation). The input signals (i.e., detected locations) are communicated via wired or wireless communication to the sensing system 10 (e.g., a controller 58). It is contemplated that in certain embodiments the GPS receiver 42 is attached to the agricultural implement 14. Additionally, in some aspects, multiple GPS receivers may be included, such as being mounted on the tow vehicle 12 and the agricultural implement 14.

As discussed above, the sensing system 10 receives the input signals. The sensing system 10 then processes the information, and associates the location information with various images data/image analysis for adjusting one or more relevant operating parameters of the tow vehicle 12 and/or the agricultural implement 14, as described in detail below.

The sensing system 10 includes a first optical sensor, such as a first camera 50. The first camera 50 is configured to capture image data (e.g., a plurality of images and/or an image stream) of a defined area 52 of the field 16 (i.e., “forward images”). Typically, the defined area 52 is in front of the tow vehicle 12, although the defined area 52 may be any defined area in front of the agricultural implement 14.

In certain embodiments, the sensing system 10 also includes a second optical sensor or second camera. For example, in one embodiment, the sensing system 10 includes a second camera 54 configured to capture image data (e.g., a plurality of images and/or an image stream) of a defined area 56 of the field 16 behind the agricultural implement 14 (i.e., “processed soil images” of soil manipulated by the agricultural implement 14). Optionally, in another embodiment, the sensing system 10 includes a third camera 55 configured to capture image data or processed soil images (e.g., a plurality of images and/or an image stream) of a defined area 57 of the field 16 adjacent the agricultural implement 14.

In an aspect, the first camera 50 and the second camera 54 are preferably spaced in a fore and aft direction relative to the agricultural implement 14. More preferably, the first camera 50 is positioned forward of the tow vehicle 12 and the second camera 54 is positioned aft of the agricultural implement 14 relative to a direction of travel of the tow vehicle 12 and/or the agricultural implement 14 across the field 16. For example, in a preferred embodiment, the first camera 50 is attached to a front of the tow vehicle 12 and the second camera 54 is attached to a rear portion of the agricultural implement 14. It is noted, however, that the fore and aft spacing of the first and second cameras 50 and 54 refers to the spacing of the cameras 50 and 54 relatively to each other (not necessarily the position of the first camera 50 being in front of the tow vehicle 12 and the position of the second camera 54 being behind the agricultural implement 14). In an embodiment that includes the third camera 55, the third camera 55 is attached to an upper portion or top of a cab of the tow vehicle 12.

The cameras 50, 54, and 55 are oriented to capture images (broadly, image data) of the ground surface of the field 16. The cameras 50, 54, and 55 may include various numbers of cameras of various types and may be configured to capture visible, ultraviolet (UV), and/or infrared (IR) light. For example, in certain embodiments, one or more of the cameras 50, 54, and 55 may include an infrared camera to capture infrared images. In certain other embodiments, one or more of the cameras 50, 54, and 55 may include an ultraviolet camera to capture ultraviolet images. Furthermore, in other embodiments, one or more of the cameras 50, 54, and 55 may include an RGB (red, green, blue) camera to capture visible, color images.

In the example, the cameras 50, 54, and 55 are coupled in electronic communication with a controller 58. In an example, the controller 58 is mounted on the tow vehicle 12 (e.g., in the cab portion). Alternatively, the controller 58 may be otherwise positioned (e.g., on the agricultural implement 14, etc.). The controller 58 includes, for example, and without limitation, various electrical, computerized, or other controllers. The controller 58 includes one or more processors coupled in communication with one or more memory devices.

Each of the cameras 50 and 54 may be oriented such that the field-of-view includes the ground in front of/behind the tow vehicle 12 and agricultural implement 14 so that the cameras 50 and 54 take images of all or a portion of the path over which the tow vehicle 12 and agricultural implement 14 travels. In embodiments that include the camera 55, the camera 55 may be oriented such that the field-of-view includes the ground adjacent the tow vehicle 12 and/or agricultural implement 14 so that the camera 55 takes images of all or a portion of the path over which the tow vehicle 12 and agricultural implement 14 previously traveled.

In some embodiments, the cameras 50, 54, and 55 are oriented such that the images collected thereby may be combined to form a single image of the ground. The images may have some overlap or no overlap. The controller 58 receives the location input signals from the GPS receiver 42 to assist the controller 58 in determining a location of the cameras 50, 54, and 55 and the images collected by the cameras 50, 54, and 55 in the field 16. Methods of combining images collected from multiple perspectives into a single image are known in the art and not described in detail herein.

In certain embodiments, the controller 58 is coupled in communication to one or more valve assemblies, which are configured to control a flow of hydraulic fluid to various hydraulic devices of the agricultural implement 14. Furthermore, the controller 58 may be coupled in communication with a CAN bus system associated with the tow vehicle 12 and/or the agricultural implement 14. As such, the controller 58 is configured to receive and process location data from the GPS receiver 42 and image data from the cameras 50, 54, and/or 55 and, in response, control various aspects of the agricultural implement 14 and/or tow vehicle 12.

In particular, aspects of the sensing system 10 and corresponding methods described herein facilitate detecting an amount of residue and/or organic matter in an imaged area (e.g., areas 52, 56, and 57) of the field 16. Furthermore, aspects of the sensing system 10 and corresponding methods facilitate controlling the agricultural implement 14 to maintain a desired residue coverage value of the field 16 and/or generate a map of residue coverage over various areas of the field 16. In addition, aspects of the sensing system 10 and corresponding methods facilitate generating a map of organic matter values over various areas of the field 16. During later operations (e.g., secondary tillage, planting, fertilizing, applying manure, etc.), these location-specific residue coverage and/or organic matter maps may be utilized to control the subsequent agricultural implements, for example, to reduce residue in areas with excess residue and/or apply more/less seeds/fertilizer in various areas of the field 16 based on the amount of organic matter present therein.

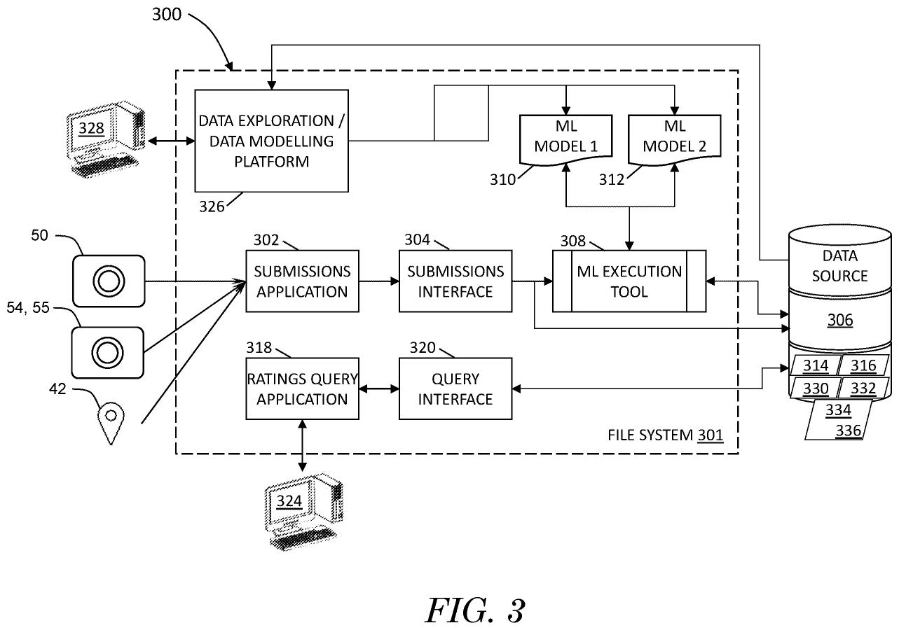

FIG. 3 is an architectural diagram of a residue and organic matter sensing platform 300 (otherwise referred to herein as the “sensing platform 300” or “platform 300”) of the sensing system 10, in accordance with one or more aspects. The sensing platform 300, at a high level, operates on a file system 301 of a computing device, such as the controller 58 (shown in FIGS. 1 and 2). The sensing platform 300 is connectable to the GPS receiver 42, the cameras 50, 54, and 55, and the control systems of the tow vehicle 12 and agricultural implement 14. The GPS receiver 42 and the cameras 50, 54, and 55 are utilized to transmit location data and raw image data, such as data 314 and 316, respectively, to an interface system. The interface system may be deployed, for example, on the controller 58.

For receiving the location and image data for determining residue and/or organic matter in the field 16, the sensing platform 300 includes a submissions application 302 (e.g., a custom API, application, etc.) configured to receive data, such as the raw image data and raw GPS coordinates, transmitted by GPS receiver 42 and the cameras 50, 54, and 55. The submissions application 302 is electronically interfaced to a submissions interface 304, which is configured to receive data submissions from the submissions application 302 and transmit the data to a data source 306 for storage. A machine learning (ML) execution tool 308 is electronically interfaced to the submissions interface 304, the data source 306, and a plurality of machine learning (ML) models, such as ML models 310 and 312. In one embodiment, the ML execution tool 308 receives the data submissions from the submissions interface 304, parses the data to ascertain the type of data being submitted, transmits the data to the data source 306, and based on the ascertained data types and a user input (e.g., via the controller 58), selects one or more of the ML models 310 and 312 for execution. The ML execution tool 308 retrieves any relevant data from the data source 306 and executes the selected model(s) using the newly submitted data and the retrieved. The results (e.g., residue coverage or organic matter values) are calculated and stored in the data source 306, for example, as residue results data 330 or organic matter results data 332.

For a data query operation, the sensing platform 300 includes a query application 318 (e.g., a custom API, application, etc.) configured to receive one or more selected query parameters input by a user, for example, via the controller 58 or a computing device 324. The query application 318 is electronically interfaced to a query interface 320 that is configured to receive a query from the query application 318. The query interface 320 is electronically interfaced to the data source 306. The query interface 320 receives the query from the query interface 320, parses the query to ascertain the selected parameters input by the user, and based on the ascertained parameters, retrieves residue results data 330 or organic matter results data 332 associated with the parameters. The results (e.g., the queried data) are returned to the query interface 320, where they are presented to the user via the query application 318.

In certain embodiments, the sensing platform 300 optionally includes a data exploration/data modelling platform 326 electronically interfaced to a computing device 328 operated, for example, by a developer and/or analyst. The data exploration/data modelling platform 326 is also electronically interfaced to the data source 306. The developer and/or analyst develops or updates ML models, such as the ML models 310 and 312, using, for example, the residue results data 330 or organic matter results data 332. For example, and without limitation, the developer and/or analyst adds and/or selects certain data to be used for a new model or for updating the current models. The data is selected, for example, based on a thorough analysis and understanding of the data. The selected data is prepared as training data 334 and a model is generated or updated therefrom. The trained or updated model is evaluated and deployed as an ML model available to the ML execution tool 308 for generating residue results data 330 or organic matter results data 332.

The ML models 310 and 312 execute various techniques for analyzing data to identify patterns and solve problems that humans cannot possibly identify or solve. Machine learning techniques have been developed that allow parametric or nonparametric statistical analysis of large quantities of data. Such machine learning techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data, such as variables inferred from the observed data points. In some embodiments, the methods and systems described herein may use machine learning techniques to identify and estimate the effects of observed or latent variables.

Use of the machine learning techniques described herein, may begin with training a machine learning program, or such techniques may begin with a previously trained machine learning program, such as the ML models 310 and 312. The residue and organic matter sensing platform 300 (e.g., the model(s)) may be trained using supervised or unsupervised machine learning, and the ML models 310 and 312 may employ a neural network, which may be a convolutional neural network, a deep learning neural network, a combined learning module or program, and the like that learns in two or more fields or areas of interest. In some embodiments, the ML models 310 and 312 may employ both color features and a neural network and/or random forest model. Additionally or alternatively, the ML models 310 and 312 may be trained by inputting sample data sets or certain data into the models (e.g., labelled residue images, organic matter images, etc. as described herein). The machine learning programs may utilize deep learning algorithms that may be primarily focused on pattern recognition and may be trained after processing multiple examples. The machine learning programs may include Bayesian program learning (BPL), image or object recognition, and/or optical character recognition—either individually or in combination. The machine learning programs may also include natural language processing, semantic analysis, automatic reasoning, and/or machine learning.

In the example, the models 310 and 312 are trained using labeled image data, such as training data 334. For example, the ML model 310 may include a residue classifier model and the ML model 312 may include an organic matter classifier model.

The ML model 310 is trained using a plurality of RGB soil images from various regions. Each of the RGB soil images is split into a plurality of sub-images. For example, in one embodiment, the sub-images are of a resolution in a range between and including about one hundred (100) pixels by about one hundred (100) pixels and two hundred and fifty (250) pixels by about two hundred and fifty (250). In one example embodiment, the sub-images are about one hundred and twenty-six (126) pixels by about one hundred and twenty-six (126) pixels. In another embodiment, the sub-images are about two hundred and twenty-four (224) pixels by about two hundred and twenty-four (224) pixels.

The plurality of sub-images are then divided into separate groups, where a first group represents sub-images of mostly soil, a second group represents sub-images of mostly residue, and a third group contains the remaining images. These first and second groups together define the training data 334. In an embodiment, the mostly soil sub-images include only those sub-images that include a ratio of soil to residue of about three-to-one (3:1) or greater. Likewise, the mostly residue sub-images include only those sub-images that include a ratio of residue to soil of about three-to-one (3:1) or greater.

The ML model 312 is also trained using a plurality of RGB soil images from various regions, which may include the same images described above for the model 310 and/or additional RGB soil images. Each of the RGB soil images is split into a plurality of sub-images.

The plurality of sub-images are then divided into separate groups, where a first group represents sub-images of mostly soil and a second group represents all the other sub-images. The first group defines a subgroup, such as subgroup 336, of the training data 334. In an embodiment, the mostly soil sub-images include only those sub-images that include a ratio of soil to residue of about three-to-one (3:1) or greater. The RGB mean and standard deviation of the subgroup 336 images provide an indication of an amount of organic matter in the imaged soil.

In supervised machine learning, the example ML models 310 and 312 may be provided with example inputs and their associated outputs, as discussed above, and each may seek to discover a general rule that maps inputs to outputs, so that when subsequent novel inputs are provided to the models, based upon the discovered rule, the models accurately determine a correct output. In unsupervised machine learning, the ML models 310 and 312 may be required to find their own structure in unlabeled example inputs. In one embodiment, at least one of the ML models 310 and 312 may be used to extract data about the item(s) from image data.

Based upon the above-described analyses, the ML models 310 and 312 may learn how to identify characteristics and patterns that may be applied to analyzing newly submitted image data received from the cameras 50, 54, and 55. For example, the ML models 310 and 312 may learn how to identify different ratios of residue (for categorization) based upon differences in the image data. Further, the ML models 310 and 312 may learn how to identify different amounts of organic matter contained in the soil of the field 16 based the RGB values of the image data.

### Exemplary Computer-Implemented Methods

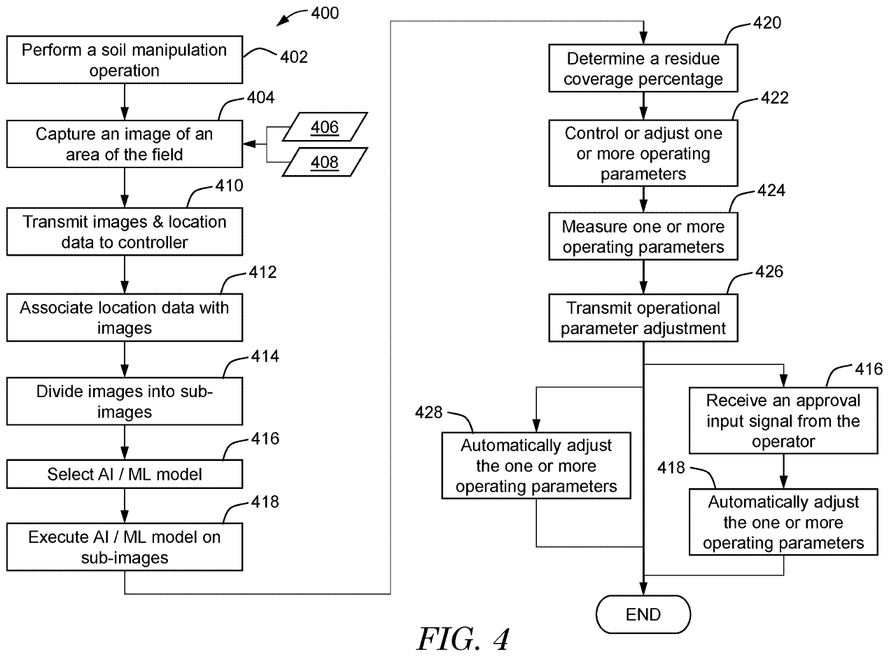

FIG. 4 is a flowchart illustrating an exemplary computer-implemented method 400 for determining an amount of residue on the soil surface of a field, such as field 16 (shown in FIGS. 1 and 2), in accordance with one aspect of the present disclosure. According to some aspects, the operations described herein may be performed in the order shown in FIG. 4 or may be performed in a different order. Furthermore, some operations may be performed concurrently as opposed to sequentially. In addition, some operations may be optional.

The computer-implemented method 400 is described below, for ease of reference, as being executed by exemplary devices and components introduced with the embodiments illustrated in FIGS. 1-3. In one embodiment, the method 400 may be implemented by the platform 300 implemented by the controller 58 (shown in FIGS. 1 and 2). While operations within the method 400 are described below regarding the controller 58, the method 400 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring also to FIG. 4, a residue sensing method 400 is implemented with respect to sensing system 10, which may be referred to as a residue sensing system. In the exemplary embodiment, at operation 402, a tow vehicle, such as the tow vehicle 12 (shown in FIGS. 1 and 2) performs a soil manipulation operation on a field, such as the field 16 (shown in FIGS. 1 and 2), using an agricultural implement, such as the agricultural implement 14. In certain aspects, the soil manipulation operation includes a tillage operation and the agricultural implement 14 is a primary or secondary tillage implement. It is contemplated, however, that other soil manipulation operations or no soil manipulation operations may be performed using other agricultural implements as part of the method 200, including for example, a fertilizing operation, a spraying operation, a planting operation, a baling operation, and the like. Furthermore, it is contemplated that the soil manipulation operation may be automated (e.g., via autonomous control of the tow vehicle 12 and the agricultural implement 14) or performed manually (e.g., via user control of the tow vehicle 12 and the agricultural implement 14).

At operation 404, the first camera 50 (shown in FIGS. 1-3) captures one or more images of an area of the field, such as the area 52 of the field 16 (shown in FIGS. 1 and 2) forward of the tow vehicle 12 (i.e., forward images 406). Additionally, in some aspects, at operation 404, the second camera 54 and/or the third camera 55 (shown in FIGS. 1-3) also capture one or more images of an area of the field, such as the areas 56 and/or 57 of the field 16 (i.e., processed soil images 408). As described above, the images may be captured as individual images (which may partly overlap) or include a continuous stream of image data. A resolution of the captured images may be, for example, about four (4) Megapixels. In examples where the captured images may be individually captured images that partly overlap, the cameras 50, 54, and 55 may be instructed to capture images based, in part, on a ground speed of the tow vehicle 12, as determined by the GPS receiver 42, a predetermined period, and/or other desirable criteria, as determined by a user of the sensing system 10.

At operation 410, the captured forward images 406 and, if captured, the processed soil images 408 are transmitted to the controller 58. Furthermore, substantially simultaneously, the GPS receiver 42 transmits location data to the controller 58. At operation 412, the controller 58 associates the received GPS location data with the respective received forward images 406 and/or processed soil images 408. It is noted that as the tow vehicle 12 and agricultural implement traverse the field 16, the processed soil images 408 will include views of substantially the same areas of the field, such as the areas 52, 56, and 57 of the field 16. The processed soil images 408, however, will include a view from a different perspective (e.g., the opposite direction) as the forward images 406. Because the location data received from the GPS receiver 42 is associated with the forward images 406 and processed soil images 408, and because the position and field of view of the cameras 50, 54, and 55 is known relative to the GPS receiver 42, the controller 58 is able to easily determine corresponding locations in the field 16 from the respective forward images 406 and/or processed soil images 408.

At operation 414, the controller 58, via the ML execution tool 308 for example, divides the forward images 406 and/or processed soil images 408 into a plurality of sub-images for processing using the ML model 310. That is, the ML execution tool 308 breaks each large image or the image stream into a plurality of sub-images.

After the plurality of sub-images are generated from the forward images 406 and/or processed soil images 408, at operation 416, the controller 58, via the ML execution tool 308 selects one or more ML models 310 and 312 that are available for the submitted data. For example, in a residue sensing operation, such as the method 400, the ML execution tool 308 selects the ML model 310, which includes a residue classifier model.

At operation 418, the ML execution tool 308 executes the selected model using the newly generated sub-images. In aspects of the disclosure, each model (or algorithm) utilizes the entirety of the sub-image data for analysis. Accordingly, every additional data point and/or image added to the data source 306 causes the system to update its calculations.

At operation 420, the sensing platform 300 determines a residue coverage percentage. The residue coverage percentage includes the percent of a particular area of field, such as the area 52 of the field 16, that is covered by residue. More particularly, at operation 420, the residue classifier ML model 310 classifies each sub-image as either “residue” or “soil.” The ML execution tool 308 reassembles the classified sub-images back into the original forward images 406, and based on the number of sub-images classified as residue as compared to the total number of sub-images of the whole images, determines a residue coverage percentage for that respective image. It is noted that the controller 58 may calculate and present to a user of the tow vehicle the instantaneous residue coverage percentage (i.e., the residue coverage percentage within the area 52 of the field 16) as the tow vehicle 12 traverses the field 16. In addition, the results of the forward images 406 calculations may be stored in the data source 306 and used to determine a residue coverage percentage for the entire field 16.

In certain aspects, the controller 58 also analyzes the forward images 406 and processed soil images 408 that correspond to the same areas of the field. The controller 58 compares the results of a forward image 406 to the results of a processed soil images 408 that corresponds to the same area of the field 16. As such, the controller 58 determines an effect of the soil-manipulation operation on that area of the field 16 by determining a change in the calculated residue coverage percentage between the forward image and the corresponding processed soil image. As discussed above, because each image is associated with GPS location data, the controller 58 may generate a residue coverage percentage map of the field 16 for later use, for example, in subsequent soil-manipulation operations.

At operation 422, the controller 58 uses the determined residue coverage percentage to automatically control or adjust one or more operating parameters of the tow vehicle 12 and/or the agricultural implement 14. For example, in a soil-manipulation operation, a user or operator of the tow vehicle 12 and the agricultural implement 14 may preset the one or more operating parameters thereof to a predetermined state. Alternatively or additionally, in some contemplated aspects, the one or more operating parameters of the tow vehicle 12 and/or the agricultural implement 14 may be automatically preset to a predetermined state. During operation, the controller 58 determines the residue coverage percentage for the area 52 in front of the tow vehicle 12, for example, from the forward images 406, and compares the residue coverage percentage to a predetermined threshold value, which may be stored in memory of the controller 58 and/or the data source 306. If the determined residue coverage percentage is less than the threshold value, the controller 58 does not adjust the one or more operating parameters preset by the operator. In some embodiments, the residue coverage determination process is repeated continuously during operation of the implement 14 in order to achieve and maintain a residue coverage percentage value below a selected threshold value. In some embodiments, the process may be repeated periodically (e.g., at intervals of five (5) seconds, ten (10) seconds, and the like).

If the determined residue coverage percentage exceeds the threshold value, at operation 424, one or more operating parameters of the tow vehicle 12 and/or the agricultural implement 14 is determined or measured (e.g., ground speed via GPS data, depth of the soil-engaging assembly 24, etc.).

At operation 426, the controller 58 transmits the determined residue coverage percentage and/or one or more operational parameter adjustments (based on the above-determined or measured operating parameters) to the operator of the tow vehicle 12 and/or the agricultural implement 14 via a display of the controller 58. At operation 430, the controller 58 may automatically transmit one or more control signals, for example, to the tow vehicle 12 and/or the agricultural implement 14, to adjust one or more operating parameters of the tow vehicle 12 and/or the agricultural implement 14 to facilitate reducing the residue coverage percentage. In embodiments where the agricultural implement 14 is equipped with a tractor implement management (TIM) system or other ISOBUS-compatible system or the like, the one or more operating parameters may be adjusted automatically. For example, the controller 58 may automatically transmit one or more instructions to an implement controller and/or controller of the tow vehicle 12 to increase or decrease, respectively, the height of the soil-engaging assembly 24 and/or the ground speed of the tow vehicle 12. Similarly, an on-board controller of the tow vehicle 12 may automatically adjust one or more operating parameters of the tow vehicle 12 (e.g., ground speed, PTO speed, etc.) in response to the residue coverage percentage data. Adjusting the one or more operating parameters facilitates reducing the residue coverage percentage proximate the rear portion of the agricultural implement 14, and thereby facilitates increasing a quality of soil of the field 16.

In some embodiments, the controller 58 may not automatically adjust the one or more operating parameters until approved by the operator (e.g., the controller 58 receives an approval input signal from the operator), as depicted in operations 428 and 430. Further, in certain embodiments (e.g., embodiments where the agricultural implement 14 is not equipped with a TIM system or other ISOBUS-compatible system), the controller 58 may only transmit the residue coverage percentage and/or a recommendation signal to adjust the one or more operating parameters to the operator of the tow vehicle 12 and/or the agricultural implement 14 via a display of the controller 58. The operator may then manually adjust the operating parameters, as desired.

In some embodiments, the method 400, or residue sensing process, is repeated continuously during operation of the tow vehicle 12 and the agricultural implement 14 to achieve and maintain a desired residue coverage percentage at or below a desired threshold value. In some embodiments, the process may be repeated periodically, as discussed above.

Thus, it will be appreciated that embodiments disclosed herein provide several advantages over the prior art, including making an objective (rather than a subjective) qualitative assessment of the amount of residue on the soil of a field, which may impact a subsequently planted crop, field erosion, and the like; automatically (rather than manually) adjusting relevant operating parameters of the agricultural implement and/or tow vehicle in order to reduce the amount of residue below a predetermined amount; and periodically or continuously repeating the residue sensing process.

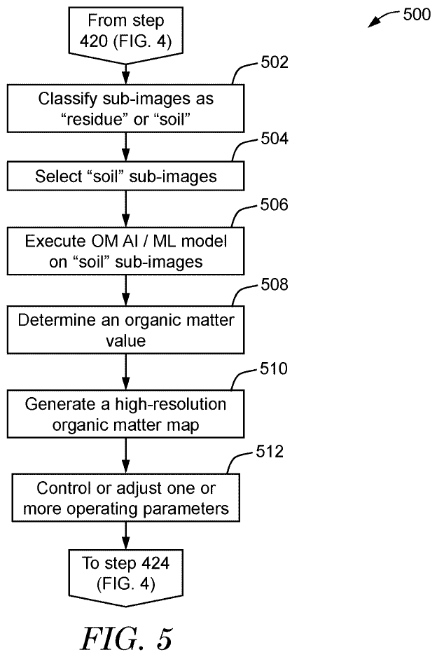

FIG. 5 is a flowchart illustrating an exemplary computer-implemented method 500 for determining an amount of organic matter in soil of a field, such as field 16 (shown in FIGS. 1 and 2), in accordance with one aspect of the present disclosure. According to certain aspects, the operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-3. In one embodiment, the method 500 may be implemented by the platform 300 implemented by the controller 58 (shown in FIGS. 1 and 2). While operations within the method 500 are described below regarding the controller 58, the method 500 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The operations of method 500 use the results of the sub-image classifier model described above as input for the organic matter determination process. As such, many of the operations are substantially similar to those of the method 400 described above, except as noted below. Thus, in the interest of clarity, the operations that are substantially the same will not be described again in detail below. Rather, only the substantial differences between the processes are describe in detail below.

Referring to FIG. 5, an organic matter sensing method 500 is implemented with respect to sensing system 10, which may be referred to as an organic matter sensing system. In the exemplary embodiment, at operation 502, after the residue classifier ML model 310 classifies each sub-image as either “residue” or “soil,” as described above in operation 420, the ML execution tool 308 selects the ML model 312, which includes an organic matter classifier model.

At operation 504, the ML execution tool 308 selects only the sub-images classified as “soil” from the newly generated sub-images. At operation 506, the ML execution tool 308 executes the selected model ML model 312 using the “soil” sub-images. In aspects of the disclosure, each model (or algorithm) utilizes the entirety of the “soil” sub-image data for analysis. Accordingly, every additional data point and/or image added to the data source 306 causes the system to update its calculations.

At operation 508, the sensing platform 300 determines an organic matter value. The organic matter value includes a determination of whether the organic matter contained in the soil is above or below a predefined threshold value at a particular area of field, such as the area 52 of the field 16. More particularly, at operation 508, the organic matter classifier ML model 312 classifies each sub-image as either “high organic matter” or “low organic matter,” based in part on the RGB data of the soil contained in the “soil” sub-images. In particular, the ML model 312 may extract the mean and standard deviation RGB color bands from each respective “soil” sub-image, and using the classifier model, predicts whether the respective “soil” sub-image indicates “high organic matter” or “low organic matter.” The ML execution tool 308 reassembles the classified sub-images back into the original forward images 406. It is noted that the controller 58 may calculate and present to an operator of the tow vehicle the instantaneous organic matter results (i.e., the organic matter result of the soil within the area 52 of the field 16) as the tow vehicle 12 traverses the field 16. In addition, the results of the forward images 406 calculations may be stored in the data source 306 for subsequent use.

At operation 510, the ML execution tool 308 generates a high-resolution organic matter map for the entire field 16, based in part, on the associated GPS location data and the organic matter determination for each sub-image. The high-resolution organic matter map includes a plurality of images captured across the field, such as the field 16.

At operation 512, the controller 58 uses the determined organic matter to automatically control or adjust one or more operating parameters of the tow vehicle 12 and/or the agricultural implement 14. For example, in a soil-manipulation operation, a user or operator of the tow vehicle 12 and the agricultural implement 14 may preset the one or more operating parameters thereof to a predetermined state. Alternatively or additionally, in some contemplated aspects, the one or more operating parameters of the tow vehicle 12 and/or the agricultural implement 14 may be automatically preset to a predetermined state. During operation, the controller 58 determines the organic matter value for the area 52 in front of the tow vehicle 12, for example, from the forward images 406. Based on the organic matter determination, the controller 58 may adjust the one or more operating parameters preset by the operator. In certain embodiments, the organic matter determination process is repeated continuously during operation of the implement 14. In some embodiments, the process may be repeated periodically (e.g., at intervals of five (5) seconds, ten (10) seconds, and the like).

Thus, embodiments provide several advantages over the prior art, including making an objective (rather than a subjective) qualitative assessment of the amount of organic matter in the soil of a field, which may impact a subsequently planted crop, fertilizer application rate, plant population, and/or plant variety placement; automatically (rather than manually) adjusting relevant operating parameters of the agricultural implement and/or tow vehicle in order to account for varying levels of organic matter; and periodically or continuously repeating the organic matter sensing process.

1. A system for determining soil organic matter, the system comprising:
a global positioning system (GPS) receiver; and
an organic matter sensing system comprising:
an optical sensor configured to capture an image of soil in an agricultural field; and
a controller operatively coupled in communication to the optical sensor and programmed, via computer-executable instructions, to:
receive the image from the optical sensor;
receive location data from the GPS sensor;
associate the location data with the image;
divide the image into a plurality of sub-images;
analyze the plurality of sub-images using a first machine learning (ML) model, the first ML model being trained to classify images into the following first classes: soil or residue;
classify, using the first ML model, each sub-image of the plurality of sub-images into one of the first classes;
process the sub-images classified in the soil class using a second ML model, the second ML model being trained to classify images into the following second classes: high organic matter or low organic matter, the second ML model being trained, using supervised learning, on image data where a mean and standard deviation of RGB data of the image data provides an indication of an amount of organic matter in the imaged soil;
classify, using the second ML model, each sub-image of the sub-images classified in the soil class into one of the second classes; and
generate an organic matter map, based on the associated GPS location data and the second classifications of the sub-images classified in the soil class.

2. The system of claim 1, further comprising a vehicle,
where the global positioning system (GPS) sensor and the residue and organic matter sensing system are attached to the vehicle,
wherein the controller is programmed via the computer-executable instructions to:
determine an organic matter result of the soil in the image; and
transmit in real-time the organic matter result to the vehicle.

3. The system of claim 2, further comprising an agricultural implement coupled to the vehicle;
wherein the agricultural implement comprises a soil-engaging assembly, wherein the soil-engaging assembly is configured to perform a soil manipulation operation on the soil; and
wherein the controller is programmed via the computer-executable instructions to transmit a recommendation signal to adjust at least one operating parameter of the agricultural implement, based on the organic matter result.

4. The system of claim 3, wherein the controller is programmed via the computer-executable instructions to automatically adjust at least one parameter selected from the group consisting of the at least one operating parameter of the agricultural implement and at least one operating parameter of the vehicle.

5. The system of claim 3, wherein the controller is programmed via the computer-executable instructions to:
receive an approval input signal from an operator in response to transmitting the recommendation signal to adjust one or more operating parameters; and
automatically adjust the one or more operating parameters in response to receiving the approval input signal.

6. The system of claim 3, wherein the agricultural implement comprises a lift mechanism operable to adjust a height of the soil-engaging assembly to a desired height during operation.

7. The system of claim 6, wherein the controller is programmed to automatically adjust at least one parameter selected from the group consisting of a height of the soil-engaging assembly and a ground speed of the vehicle.

8. The system of claim 7, wherein:
the agricultural implement and the vehicle are equipped with a tractor implement management (TIM) system or an ISOBUS-compatible system; and
the controller is programmed to automatically adjust the ground speed of the vehicle autonomously in response to a control signal transmitted by the controller to the vehicle.

9. The system of claim 1,
wherein the controller is programmed via the computer-executable instructions to, as part of the operation of determining the organic matter result of the soil in the image, reassemble the sub-images which have been classified in the soil class and into one of the second classes.

10. The system of claim 2, wherein:
the operations performed by the controller are performed iteratively as the vehicle traverses the agricultural field; and
the organic matter map comprises a plurality of images captured by the optical sensor as the vehicle traverses the agricultural field.

11. A method for determining organic matter within soil of an agricultural field, the method performed by a controller attached to a vehicle traversing the agricultural field, the method comprising:
receiving an image from an optical sensor attached to the vehicle, the image comprising an image of the soil within the agricultural field;
receiving, from a global positioning system (GPS) sensor attached to the vehicle, location data;
associating the location data with the image;
dividing the image into a plurality of sub-images;
analyzing the plurality of sub-images using a first machine learning (ML) model, the first ML model being trained to classify images into the following first classes: soil or residue;
classifying, using the first ML model, each sub-image of the plurality of sub-images into one of the first classes;
processing the sub-images classified in the soil class using a second ML model, the second ML model being trained to classify images into the following second classes:
high organic matter or low organic matter, the second ML model being trained, using supervised learning, on image data where a mean and standard deviation of the RGB data of the image data provides an indication of an amount of organic matter in the imaged soil;
classifying, using the second ML model, each sub-image of the sub-images classified in the soil class into one of the second classes; and
generating an organic matter map, based on the associated GPS location data and the second classifications of the sub-images classified in the soil class.

12. The method of claim 11, further comprising:
determining an organic matter result of the soil in the image; and
transmitting in real-time the organic matter result to the vehicle.

13. The method of claim 12,
wherein the vehicle is towing an agricultural implement;
wherein the agricultural implement comprises a soil-engaging assembly, wherein the soil-engaging assembly is configured to perform a soil manipulation operation on the soil; and
wherein the method comprises transmitting a recommendation signal to adjust one or more operating parameters of the agricultural implement, based on the organic matter result.

14. The method of claim 13, further comprising:
automatically adjust at least one parameter selected from the group consisting of the at least one operating parameter of the agricultural implement and at least one operating parameter the vehicle.

15. The method of claim 12, further comprising:
receiving an approval input signal from an operator in response to transmitting the recommendation signal to adjust one or more operating parameters; and
automatically adjusting the one or more operating parameters in response to receiving the approval input signal.

16. The method of claim 13, wherein the agricultural implement includes a lift mechanism operable to adjust a height of the soil-engaging assembly to a desired height during operation.

17. The method of claim 16, wherein the operation of automatically adjusting the at least one operating parameter comprises automatically adjusting at least one parameter selected from the group consisting of a height of the soil-engaging assembly and a ground speed of the vehicle.

18. The method of claim 17, wherein:
the agricultural implement and the vehicle are equipped with a tractor implement management (TIM) system or an ISOBUS-compatible system; and
the operation of automatically adjusting the ground speed of the vehicle is performed autonomously in response to a control signal transmitted by the controller to the vehicle.

19. The method claim 12, wherein the operation of determining the organic matter result of the soil in the image comprises reassembling the sub-images that have been classified in the soil class and into one of the second classes.

20. The method of claim 12, further comprising:
iteratively performing the operations as the vehicle traverses the agricultural field,
wherein the organic matter map comprises a plurality of images captured by the optical sensor as the vehicle traverses the agricultural field.
